(19) United States
(12) Patent Application Publication
(10) Pub. No.: US 2026/0283223 A1
(43) Pub. Date: Sep. 24, 2026

(54) VARIABLE-CAPACITY STORE

(71) Applicant: G.D S.P.A., Bologna (IT)

(72) Inventors: Luca Calzolari, Bologna (IT); Marco Sassi, Bologna (IT)

(21) Appl. No.: 19/475,769

(22) PCT Filed: Apr. 17, 2024
(86) PCT No.: PCT/IB2024/053728

§ 371 Date: Oct. 16, 2025

(30) Foreign Application Priority Data
Apr. 17, 2023 (IT) 102023000007419

(51) Int. Cl. A24C 5/35; A24C 5/32; B65G 21/18; B65G 47/51

(52) U.S. Cl. CPC A24C 5/35; A24C 5/322; B65G 21/18; B65G 47/5131; B65G 2201/0226; B65G 2207/24

(57) ABSTRACT

A variable-capacity store for cylindrical products of the tobacco processing industry; the store comprises a conveying assembly comprising a first conveyor; a second conveyor arranged above the first conveyor; a transfer conveyor assembly, which is configured to convey products from the first conveyor to the second conveyor; a moving assembly for moving the input of the transfer conveyor assembly along the first conveyor and the output of the transfer conveyor assembly along the second conveyor; a first and a second joining device, which are configured to permit the transit of the products between the conveyors, movable on the first conveyor and the second conveyor, respectively, and provided with centering elements arranged at the sides of the first and second conveyors, respectively.

### CROSS-REFERENCE TO RELATED APPLICATIONS

This Patent Application claims priority from Italian Patent Application No. 102023000007419 filed on Apr. 17, 2023, the entire disclosure of which is incorporated herein by reference.

### TECHNICAL FIELD

The present invention relates to a variable capacity store for products, in particular cylindrical products of the tobacco processing industry.

### BACKGROUND OF THE INVENTION

Variable-capacity stores for cigarettes of the type described in patent EP581143 are known in the tobacco processing industry. These stores comprise a variable-length storage path with two conveyor portions wound around each other on a common axis with coils having the same inclination; and a deflection device, which is configured to move cigarettes from one portion to the other and is movable along both portions so as to vary the overall length of the storage path.

EP838165 describes a variable-capacity store comprising two helical conveyors arranged one above the other and connected by an intermediate element configured to transfer products from the upper conveyor to the lower conveyor by gravity alone. The two conveyors operate pneumatically.

This type of store has several drawbacks, among which are the following.

The particular arrangement of the two conveyor portions arranged one inside the other not only makes the structure and construction of the stores particularly complex and costly, but also complicates maintenance work to a great extent.

Furthermore, the stores are not very ductile as it is not possible to provide input and output stations for cylindrical products arranged in opposite positions (e.g. one at the bottom and one at the top). More specifically, EP581143 and EP838165 disclose that the product output is at the bottom, a position that is not particularly convenient for the layouts of current machines (such as, for example, cigarette packers or combiners for combining filters and tobacco sticks together) that can be found downstream of the stores.

It should also be noted that pneumatic conveyors (such as, for example, described in EP838165) are not very gentle on products (in particular, cigarettes). In fact, this type of conveyor can not only damage products relatively easily, but can also lead to the detachment and dispersion of particles (e.g. tobacco) from the products themselves.

It is also noted that a gravity-only feeding of relatively delicate products (such as cigarettes) can lead to damage to products and/or the creation of clogging.

WO2019073447A1 describes a variable-capacity store for products of the tobacco processing industry, comprising a conveying assembly comprising a first conveyor having a substantially helical shape; a second conveyor having a substantially helical shape and arranged above the first conveyor; and a linear transfer conveyor, capable of conveying products from the first conveyor to the second conveyor, having a variable length. This type of store has a number of shortcomings, including: the fact that the mobile connection between the conveyors is difficult to make and not very stable (the connection can fail); and the fact that, especially at the connections between the different conveyors, it is possible that bottlenecks can occur due to, for example, some products becoming trapped.

The purpose of the present invention is to provide a variable-capacity store, which overcomes, at least partially, the drawbacks of the prior art and is, at the same time, easy and inexpensive to implement.

### SUMMARY

In accordance with the present invention, a variable-capacity store is provided as claimed in the independent claim below, and preferably in any of the claims directly or indirectly dependent on the said independent claim.

### BRIEF DESCRIPTION OF THE DRAWINGS

The present invention will now be described with reference to the accompanying drawings, which show a non-limiting embodiment thereof, wherein:

FIGS. 1 to 5 are perspective views in successive operational conformations of a store made in accordance with the present invention;

FIG. 6 is a side view of a component of the store in FIGS. 1-5;

FIG. 7 is a section of a detail of the store in FIGS. 1-5;

FIG. 8 is a perspective view of the machine in FIGS. 1-5 with some details removed for clarity;

FIG. 9 is a perspective view of the component in FIG. 6 connected to an additional element;

FIG. 10 is a perspective view of components of the store in FIGS. 1-5;

FIG. 11 is a perspective view of a detail of the store in FIGS. 1-5; and

FIG. 12 is a perspective view from below of a detail of FIG. 11.

### DETAILED DESCRIPTION

In the accompanying figures, 1 indicates a variable-capacity store for products 2. The store includes a conveying assembly 3 for conveying the products 2 (in particular, en masse) from an input station 4 to an output station 5 along a path P with a variable length.

In particular, the products 2 are substantially cylindrical products of the tobacco processing industry. For example, the products 2 are cigarettes, cigarette filters, cigarette filter components (blanks), tobacco sticks, cartridges and/or components for electronic cigarettes. According to some specific and non-limiting embodiments, the products 2 are cigarettes.

The conveying assembly 3 comprises a conveyor 6 for feeding the products 2 from the input station 4 along a segment S1 of the path P; at least one conveyor 7 for feeding the products 2 to the output station 5 along a segment S2 of the path P; and at least one transfer conveyor assembly 8, which is configured to convey the products 2 from the conveyor 6 to the conveyor 7 along an intermediate segment IS (in particular, substantially linear) of the path P and has an input 9, arranged at the segment S1 to receive the products 2 from the conveyor 6, and an output 10, arranged at the segment S2 to feed the products to the conveyor 7.

In particular, the conveyors 6 and 7 (and, in some cases, the transfer conveyor assembly 8) are endless conveyors.

According to some non-limiting embodiments, the transfer conveyor assembly 8 is arranged between the conveyors 6 and 7.

Advantageously, but not necessarily, the transfer conveyor assembly 8 is arranged to the side of the conveyors 6 and 7.

Advantageously, but not necessarily, the transfer conveyor assembly 8 is configured to convey the products 2 upwards.

The segment S1 (which, in particular, has a substantially helical shape) extends from the input station 4 to the input 9. The segment S2 (which, in particular, has a substantially helical shape) extends from the output 10 to the output station 5.

The store 1 also comprises a moving assembly 12 to move the transfer conveyor assembly 8 so as to move said input 9 and said output 10 along the conveyor 6 and conveyor 7, respectively. In particular, the moving assembly 12 is also (consequently) configured to vary the length of the intermediate segment IS and the segments S1 and S2.

It is noted that by lengthening the segments S1 and S2, the capacity of the store 1 is increased; by shortening the segments S1 and S2, the capacity of the store 1 is decreased.

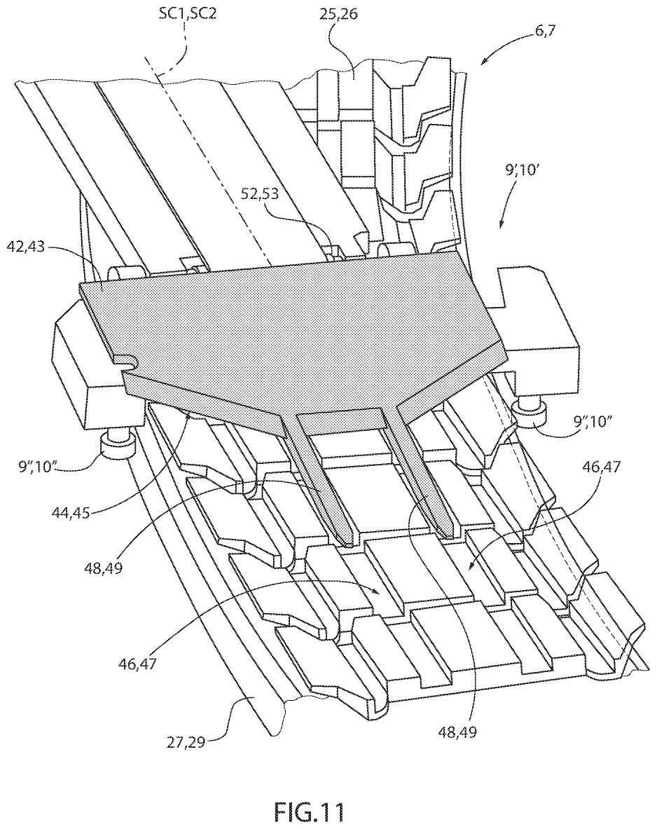

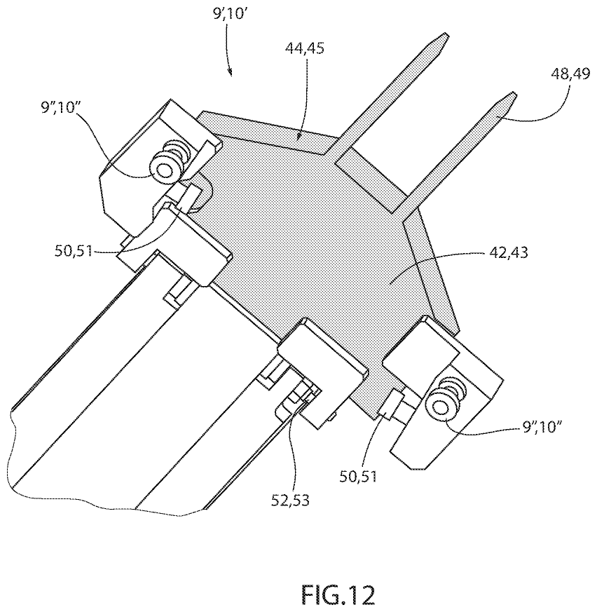

Referring in particular to FIGS. 11 and 12, the conveying assembly 3 comprises a joining device 9′, which is configured to permit the transit of the products 2 from the conveyor 6 to the transfer conveyor assembly 8 and is movable on the conveyor 6; and/or a joining device 10′, which is configured to permit the transit of products 2 from the transfer conveyor assembly 8 to the conveyor 7 and is movable on the conveyor 7.

In particular, the joining device 9′ comprises at least two centring elements 9″, which are arranged on opposite sides of the conveyor 6 to reduce the lateral movement of the joining device 9 relative to the conveyor 6.

In particular, the joining device 10′ comprises at least two centring elements 10″, which are arranged on opposite sides of the conveyor 7 to reduce the lateral movement of the joining device 10 relative to the conveyor 7.

Each centring element 9″ comprises (is) at least one first roller (in particular, at least one bearing-roller bearing) and/or each centring element 10″ comprises (is) at least one second roller (in particular, at least one bearing-roller bearing).

It has been observed experimentally that, in this way, it is possible to achieve more stable and reliable connections of the transfer conveyor assembly 8 with the conveyors 6 and/or 7 (a more precise relative position) and a reduction in clogging. Advantageously, but not necessarily, conveying assembly 3 comprises both the joining device 9′ and the joining device 10′.

According to some preferred but not limiting embodiments, the joining elements 9′ and 10′ are substantially the same. In this respect, note that FIGS. 11 and 12 represent both the joining device 9′ and the joining device 10′.

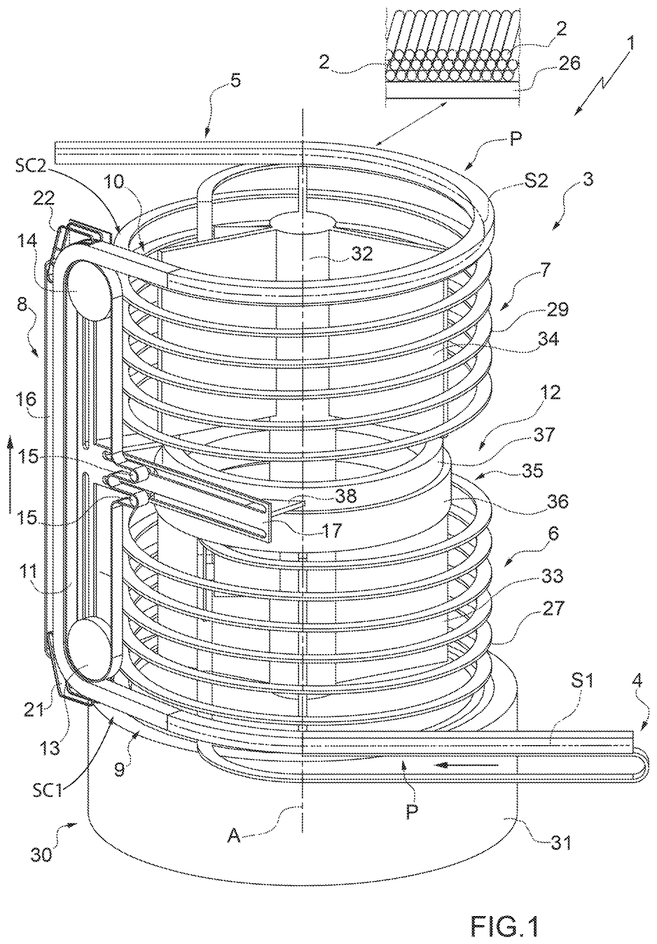

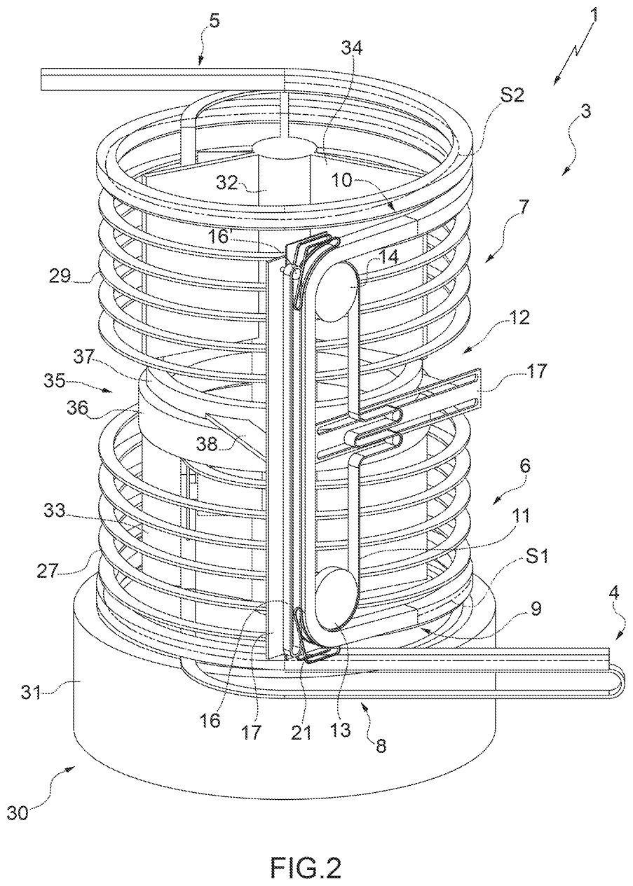

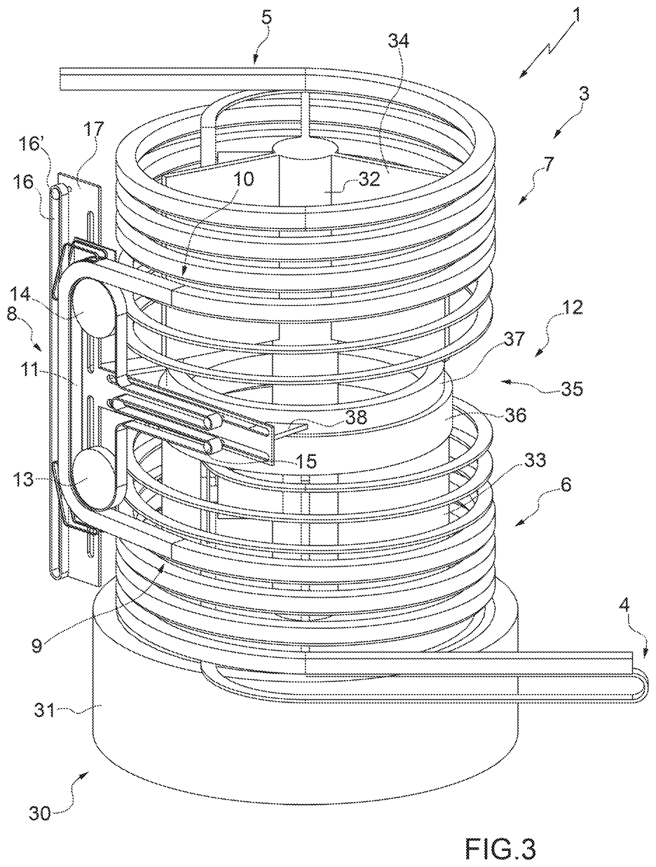

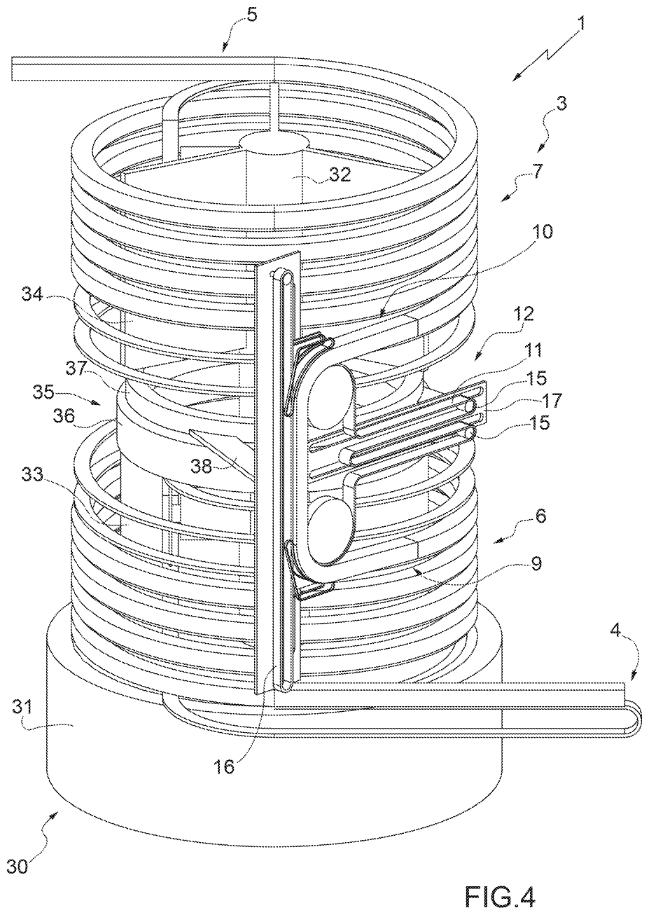

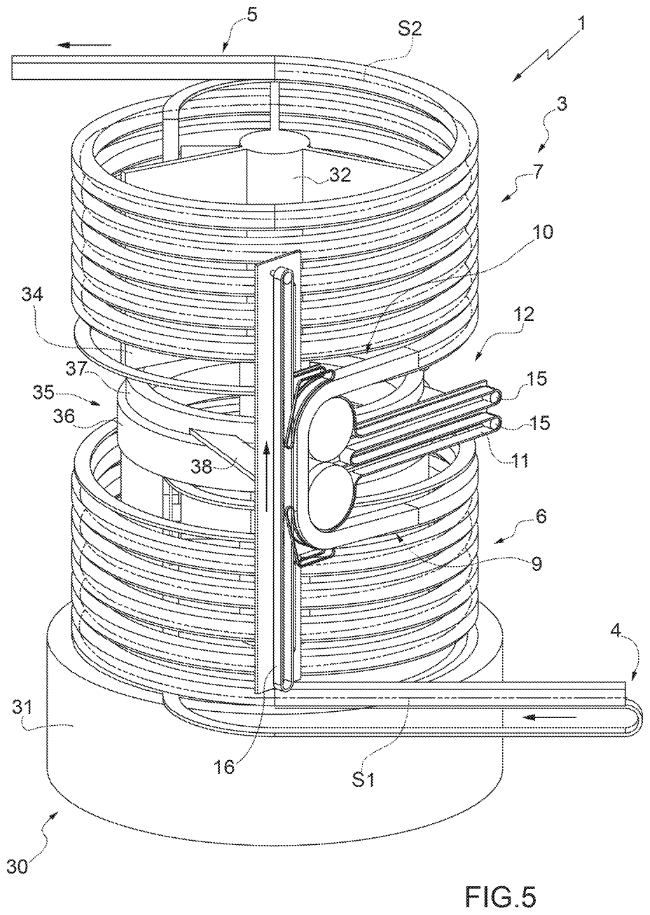

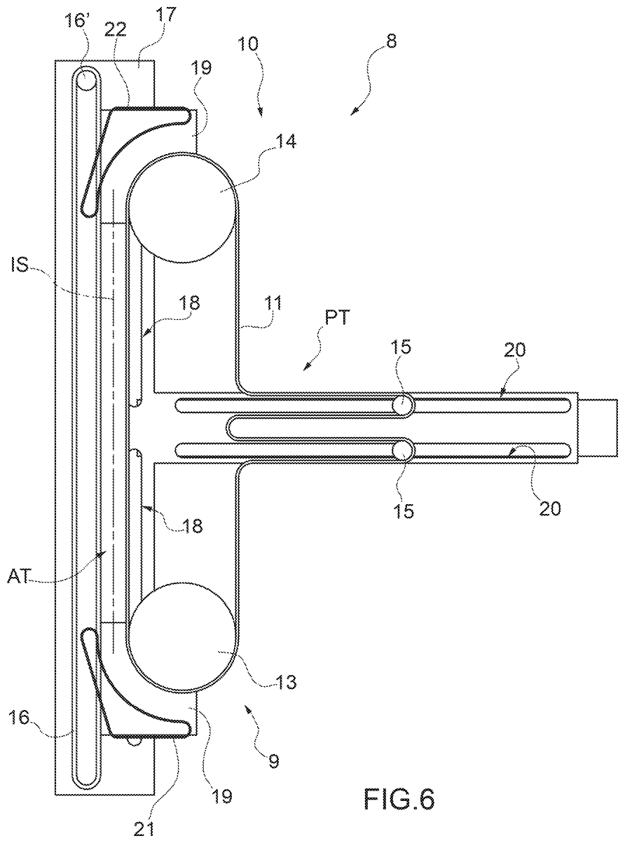

In particular, the moving assembly 12 (FIGS. 1-5) is configured to move the transfer conveyor assembly 8 so as to move the joining device 9′ and/or the joining device 10′ along the conveyors 6 and 7, respectively.

Advantageously, but not necessarily, the transfer conveyor assembly 8 has at least one feeding device 11 configured to (at least partially) accompany the products 2, moving (together with the products) along the intermediate segment IS.

In particular, the feeding device 11 comprises (is) an elongated element closed onto itself. According to some non-limiting embodiments, the feeding device 11 comprises (is) a strap, belt and/or chain.

The presence of the feeding device 11 reduces the risks of clogging of the products 2 along the intermediate segment IS and of the products 2 being damaged while they are conveyed along the intermediate segment IS during use. Thanks to the feeding device 11, it is also possible to feed products 2 from the conveyor 6 at the bottom to the conveyor 7 at the top.

Advantageously but not necessarily, the feeding device 11 is configured to move (at least partially) the products 2, moving (together with the products) along the intermediate segment IS.

In particular, the intermediate segment IS extends between the input 9 and the output 10 (more specifically, from the input 9 to the output 10).

The input 9 and output 10 are movable along the conveyor 6 and the conveyor 7, respectively.

In particular, each conveyor 6 and 7 has at least one respective turn (e.g. a helix and/or a coil). Advantageously, but not necessarily, each conveyor 6 and 7 has a plurality of respective turns (coils). In other words, each conveyor 6 and 7 is wound onto itself in such a way as to present a plurality of turns (coils). More specifically, the winding direction of the conveyor 6 is opposite to the winding direction of the conveyor 7. For example, if (looking from above) the winding direction of the conveyor 7 is clockwise, the winding direction (again looking from above) of the conveyor 6 is anti-clockwise.

Advantageously, but not necessarily, the conveyor 6 has a plurality of first turns (coils) and the conveyor 7 has a plurality of second turns (coils) having the same radius and pitch as the first turns.

According to specific, non-limiting embodiments, the conveyor 6 has a plurality of constant-radius, constant-pitch turns; the conveyor 7 has a plurality of constant-radius, constant-pitch turns. More specifically, the conveyor 6 has at least one section with a helical (cylindrical) shape with a constant radius and pitch; the conveyor 7 has at least one section with a helical (cylindrical) shape with a constant radius and pitch.

According to alternative, non-depicted embodiments, each turn comprises two curved end portions and two linear central portions. In such cases, for example, the turns extend around two drums with parallel axes (see e.g. FIG. 1 of EP738478 by the same applicant).

Advantageously, but not necessarily, the transfer conveyor assembly 8 comprises a pulley 13 and a pulley 14, around which the feeding device 11 is partially wound. In particular, the store 1 (more precisely, the transfer conveyor assembly 8) includes at least one drive assembly (of a type known per se and not depicted) to rotate at least one of the pulleys 13 and 14. More specifically, it is to be noted that the transfer conveyor assembly 8 is structured in such a way that the output 10 is arranged at (more precisely, at the height of) the pulley 14 and the input 9 is arranged at (more precisely, at the height of) the pulley 13.

According to some non-limiting embodiments, the aforementioned drive unit comprises (is) a motor and/or a kinematic mechanism connected to other parts of the store 1.

Advantageously, but not necessarily, the store 1 (in particular, the transfer conveyor assembly 8; more particularly, the moving assembly 12) comprises an actuator assembly (of a type known per se and not depicted) to bring the pulleys 13 and 14 towards and away from each other, in particular in a longitudinal extension direction of the intermediate segment IS (more particularly, in a substantially vertical direction).

According to some non-limiting embodiments, the above-mentioned actuator assembly comprises (is) a motor and/or a kinematic mechanism connected to other parts of the store 1.

In particular, the aforementioned actuator assembly is configured to vary the distance between the pulleys 13 and 14 according to (proportional to) the difference between the speeds at which the conveyor 6 and the conveyor 7 convey the products 2. More specifically, the actuator assembly is configured to vary the distance between the pulleys 13 and 14 with a speed proportional to the difference between the speeds at which the conveyor 6 and the conveyor 7 convey the products 2.

According to some non-limiting embodiments, the feeding device 11 comprises a variable length active segment AT extending along the intermediate segment IS between the pulleys 13 and 14 and a passive segment PT arranged on the opposite side of the pulleys 13 and 14 from the active section AT (in other words, so that the pulleys 13 and 14 are arranged between the active section AT and the passive section PT). The passive section PT extends between the pulleys 13 and 14 and partially around at least one further pulley 15 of the transfer conveyor assembly 8, which also includes a further actuator assembly (also known and not depicted) to move the pulley 15 (away from and towards the intermediate segment IS).

It should be noted that, advantageously, the relative movement between the pulleys 13 and 14 and the movement of the pulley 15 are linked so that one compensates the other (and the feeding device 11 always remains correctly tensioned). In other words, when the active segment AT is shortened by a given length, the passive segment PT is extended by the given length and vice versa.

In some non-limiting cases, the additional actuator assembly comprises a kinematic mechanism that transfers, according to a defined proportional ratio (e.g. 1 to 1), the relative movement (more precisely, displacement) of the pulleys 13 and 14 to the pulley 15.

In particular, the transfer conveyor assembly 8 comprises at least one pulley 15 and at least two fixed pulleys (per se known and not depicted-typically, arranged one above the other). More precisely, but not necessarily, the pulley 15 is placed (at an intermediate height) between the two fixed pulleys and is movable (horizontally) towards and away from the fixed pulleys. The relative movement between the pulley 15 on one side and the fixed pulleys on the other compensates for the relative movement between the pulleys 13 and 14.

According to some specific and non-limiting embodiments (such as the one depicted), the transfer conveyor assembly 8 comprises at least two pulleys 15 and at least three fixed pulleys (per se known and not depicted). In these cases, the relative movement between the pulleys 15 on one side and the fixed pulleys on the other compensates for the relative movement between the pulleys 13 and 14.

Advantageously, but not necessarily, the transfer conveyor assembly 8 comprises at least one further feeding device 16, which is arranged facing the feeding device 11 and is configured to move along the intermediate segment IS (in particular, in a coordinated manner with the feeding device 11; more precisely, at the same speed as the feeding device 11). In particular, the feeding device 11 and the feeding device 16 are adapted to clamp the products 2 together and accompany (move) them at least partially along the intermediate segment IS.

More precisely, the feeding device 16 comprises (is) a belt, a strap and/or a chain. Advantageously, but not necessarily, the transfer conveyor assembly 8 comprises a motor (electric-of a type known per se and not depicted) to drive (rotate) one of the pulleys 16′ and a different motor (electric-of a type known per se and not depicted) to drive (rotate) one of the pulleys 14 and 13 (in particular, the pulley 14). In particular, the store 1 (more precisely, the transfer conveyor assembly 8) comprises a control unit configured to drive the two electric motors in a coordinated manner so that the speeds of the feeding devices 11 and 16 are equal to each other (even when the pulleys 13 and 14 move away from or towards each other). For example, in use, when the pulleys 13 and 14 move away from each other and the speed of rotation of the pulleys 16′ is kept constant (so that the speed of movement of the products 1 along the segment IS does not vary), the speed of rotation of the pulley 14 is decreased.

According to some alternative and non-limiting embodiments, the feeding device 16 is wound around a pair of pulleys 16′ (one of which is depicted). In particular, one of the pulleys 16′ is connected by means of a kinematic mechanism (of a type known per se and not depicted) to at least one of the pulleys 14 and 13, which kinematic mechanism (connected to a motor) is configured to transfer the rotary motion of the pulleys 13 and 14 to the pulley 16′ so that the speeds of the feeding devices 11 and 16 are equal to each other.

The feeding device 16 further reduces the risks of clogging of the products 2 along the intermediate segment IS and of the products 2 being damaged while they are conveyed along the intermediate segment IS during use. The feeding device 16 also makes it possible to improve the feeding of the products 2 from the conveyor 6 arranged at the bottom to the conveyor 7 arranged at the top.

According to certain non-limiting embodiments, the transfer conveyor assembly 8 comprises a plate 17 on which the above-mentioned pulleys are mounted (in particular, the pulleys 13 and 14 and possibly the pulley 15, the pulleys 16′ and the fixed pulleys). In particular, the plate 17 has slits 18 that act as guides for the pulleys 13 and 14. In other words, in use, the pulleys 13 and 14 each run along a respective slit 18.

Alternatively or additionally, the transfer conveyor assembly 8 comprises two flat supports 19, on which the pulleys 13 and 14 are mounted, respectively, (rotatably). More precisely, the above-mentioned actuator assembly (not shown) is configured to move the flat supports 19.

In some cases, the flat supports 19 slide along the slits 18 or are movable along linear guides. The movement of the flat supports 19 can, for example, be achieved by means of linear actuators and/or kinematic mechanisms connected to other parts of the store 1.

Additionally or alternatively, the plate 17 has slits 20 that serve as guides for the pulley(s) 15. In other words, in use, the pulley(s) 15 run(s) along a respective slit 20.

According to alternative, non-limiting embodiments, the pulleys 15 are mounted on respective movable sliders along linear guides. The movement of these sliders can, for example, be achieved by means of linear actuators and/or kinematic mechanisms connected to other parts of the store 1.

Advantageously, but not necessarily, the joining device 9′ and the joining device 10′ move in the direction of the longitudinal extension of the intermediate segment IS integrally with a respective pulley 13 and 14.

According to some non-limiting embodiments, the transfer conveyor assembly 8 further comprises a deflection belt 21 arranged at the pulley 13 to direct (by changing their direction of travel) the products 2, coming from the input 9, into the intermediate segment IS. In addition or alternatively, the transfer conveyor assembly 8 further comprises a deflection belt 22 arranged at the pulley 14 to direct (by changing their direction of travel) the products 2, coming from the intermediate segment IS, towards the output 10.

In particular, the deflection belts 21 and 22 are movable relative to each other integrally with the pulleys 13 and 14, respectively. According to some non-limiting embodiments, the deflection belts 21 and 22 are each mounted on a respective flat support 19.

Advantageously, but not necessarily, the conveyors 6 and 7 are arranged so that one is (at least partially) above the other. In particular, the conveyor 7 is arranged (at least partially) above the conveyor 6 (and the output station 5 is arranged higher than the input station 4). This makes it possible to have the output 10 in a relatively high position in relation to the input 9.

In some non-limiting cases, the output station 5 is arranged higher than the output 10, which is, in turn, placed higher than the input 9, which is placed above the input station 4.

More precisely (the conveyors 6 and 7 are arranged in such a way that), the segments S1 and S2 are basically coaxial with each other.

According to some non-limiting embodiments, the intermediate segment IS is (linear and) substantially parallel to an axis A around which the segment S1 and the segment S2 are wound. Alternatively or additionally, the first portion is essentially vertical.

In accordance with specific non-limiting embodiments, the path P also has two connecting segments SC1 and SC2 (crosswise-in particular, perpendicular-to the first portion) extending between the intermediate segment IS and the sections S1 and S2, respectively. The transfer conveyor unit 8 is configured to convey the products 2 also along the connecting segments SC1 and SC2.

More precisely, but not necessarily, the connecting segments SC1 and SC2 extend substantially horizontally.

According to some non-limiting embodiments, the transfer conveyor assembly 8 comprises conveyors with movable (essentially horizontal) conveyor elements at the connecting segments SC1 and SC2.

Advantageously, but not necessarily, the moving assembly 12 is configured to rotate the transfer conveyor unit 8 about the axis A.

In use, as the moving assembly 12 rotates the transfer conveyor unit 8 about the axis A, the input 9 (more precisely, the joining device 9′) moves (slides) along the conveyor 6 and the output 10 (more precisely, the joining device 10′) moves (slides) along the conveyor 7. In order to make the input 9 follow the conveyor 6 and the output 10 follow the conveyor 7, the distance between the pulleys 13 and 14 is varied.

FIGS. 1 to 5 show the store 1 in successive operating steps while the store 1 itself is being filled. These figures illustrate what has been mentioned above, i.e. that the rotational movement is also associated with a change in the length of the segment IS (in other words, a change in the distance between the pulleys 13 and 14).

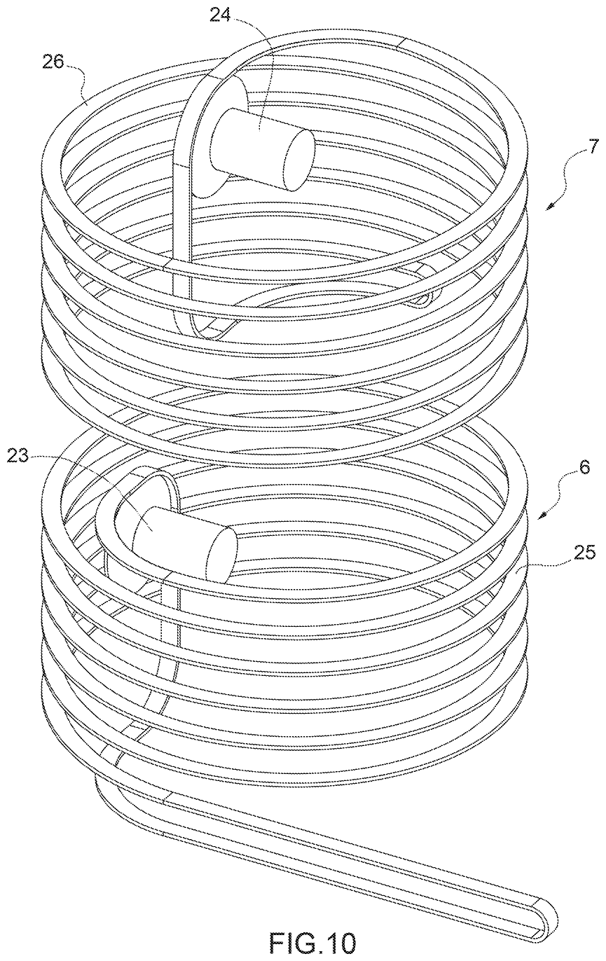

As better shown in FIG. 10, the conveyor 6 comprises at least one motorised pulley 23 and the conveyor 7 comprises at least one motorised pulley 24. The pulleys 23 and 24 are designed to allow the movement of a transporting element 25 and, respectively, a transporting element 26 along the segment S1 and S2, respectively, (and along their return segments). Together, the segment S1 and the respective return segment define a path closed onto itself (typical of an endless conveyor). Together, the segment S2 and the respective return segment define a path closed onto itself (typical of an endless conveyor).

The transporting element 25 is, according to some non-limiting embodiments, a belt, strap and/or chain. Advantageously but not necessarily, the transporting element 25 is a chain. More precisely, the transporting element 25 is a chain as, for example, described in U.S. Pat. No. 6,364,094 and/or WO2013141807.

The transporting element 26 is, according to some non-limiting embodiments, a belt, strap and/or chain. Advantageously but not necessarily, the transporting element 26 is a chain. More precisely, the transporting element 26 is a chain as, for example, described in U.S. Pat. No. 6,364,094 and/or WO2013141807.

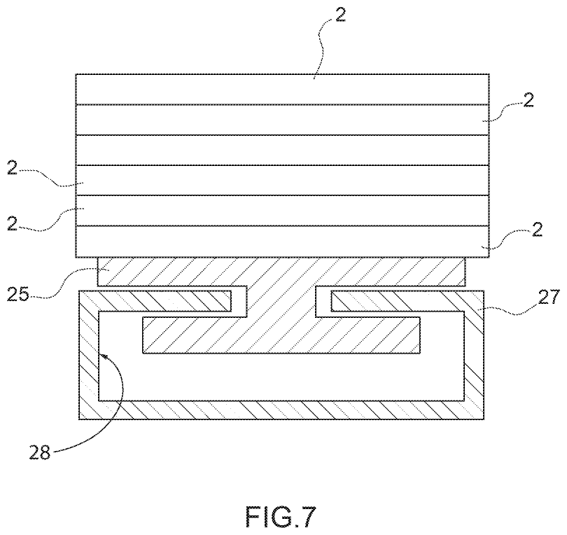

The transporting elements 25 and 26 allow for gentle handling of the products 2. Advantageously but not necessarily, the conveyor 6 comprises (FIG. 7) a guide (a track) 27.

In particular, the transporting element 25 is configured to slide on the guide 27.

According to some non-limiting embodiments, the guide 27 is provided with a recess 28 within which a (lower) protuberance of the transporting element 25 extends. Thanks to this structure, the element 25 follows the guide 27 and moves along the segment S1. In this regard, note that the guide 27 extends along the path S1; more precisely, the guide 27 presents the shape of the path S1 (and defines the path S1).

In addition or as an alternative, the conveyor 7 comprises a guide (track) 29.

In particular, the transporting element 26 is configured to slide on the guide 29.

According to some non-limiting embodiments, the guide 29 has a similar structure and function to the guide 29. The guide 29 extends along the path S2; more precisely, the guide 29 presents the shape of the path S2 (and defines the path S1). Advantageously, but not necessarily, the centring elements 9″ (the rollers) are arranged on opposite sides of the guide 27 and essentially in contact with the guide 27 itself.

Additionally or alternatively, the centring elements 10″ (the rollers) are arranged on opposite sides of the guide 29 and are essentially in contact with the guide 29 itself.

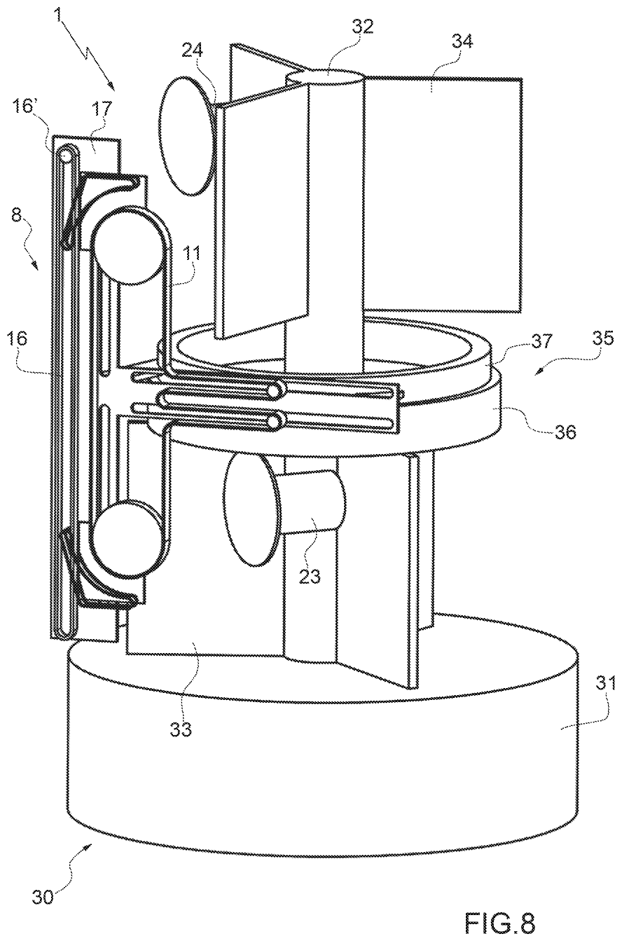

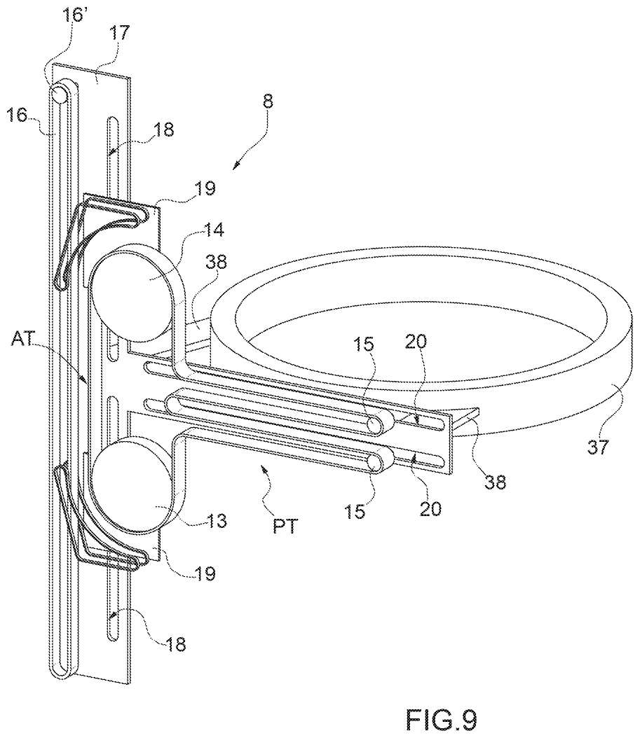

Referring in particular to FIG. 8, according to some non-limiting embodiments, the store 1 also comprises a main support structure 30 supporting the conveyors 6 and 7 (more precisely, the guides 27 and 29) and the transfer conveyor assembly 8.

According to some non-limiting embodiments, the main support structure 30 comprises a base 31 and a support column 32 projecting (perpendicularly) from the base 31. More specifically, the column 32 extends parallel to the axis A; more specifically, the column 32 extends along the axis A (in other words, the axis A is—also—the longitudinal axis of the column 32). More precisely, the column 31 has a vertical orientation.

According to some non-limiting embodiments, the main support structure 30 also comprises a support assembly 33 fixed to the column 32 and carrying the conveyor 6 (more precisely, the guide 27) and a support assembly 34 fixed to the column 32, spaced from the support assembly 33 and carrying the conveyor 7 (more precisely, the guide 29).

Moreover, in some cases (such as the one depicted), the main support structure 30 also comprises a bearing 35, which, in particular, is interposed between the support assembly 33 and the support assembly 34 and is carried by the support assembly 33. The bearing 35 is part of the moving assembly 12. More specifically, the bearing 35 comprises a fixed portion 36 mounted on the support assembly 33 and a movable portion 37 configured to rotate about the axis A and carrying the transfer conveyor assembly 8. More specifically, the transfer conveyor assembly 8 is mounted integral to the bearing 35 (more precisely, to the movable portion 34) by means of two arms 38.

According to certain non-limiting embodiments, the moving assembly 12 comprises at least one motor (of a type known and not depicted) configured to move the transfer conveyor assembly 8 (more precisely, rotate the transfer conveyor assembly 8 about the axis A). In these cases, in particular, the store 1 comprises sensors (encoders-of a known type and not shown) to detect the speed difference between the conveyors 6 and 7 (more precisely, between the motorised pulleys 24 and 25) and a control unit to drive the moving assembly 12 according to this difference.

Advantageously, but not necessarily, the above-mentioned actuator assembly (to move the pulleys 13 and 14 towards and away from each other) includes a kinematic mechanism (e.g. worm gear system) connected to the motor of the moving assembly 12 to transmit motion (according to a particular proportion) to the pulleys 13 and 14 (to move away and/or towards each other).

Advantageously, but not necessarily, the transfer conveyor assembly 8 is configured to change the speed at which the length of the intermediate segment varies depending on the speed of rotation imparted by the moving assembly 12 about the axis of rotation (in this regard, see, for example, WO2019073447A1).

According to some embodiments, the moving assembly 12 comprises a mechanical connection configured to move the transfer conveyor assembly 8 (more precisely, rotate the transfer conveyor assembly 8 about the axis A) according to the speed differences between the conveyors 6 and 7 (more precisely, between the motorised pulleys 24 and 25).

Typically, in use, the store 1 is placed between a first machine (e.g. a cigarette production machine) and a second machine (e.g. a packaging machine) in order to compensate for the different speeds at which the first machine feeds the products 2 to the store 1 and the second machine uses the products 2 from the store. More precisely, the store 1 comprises a control system connected to the first and second machines (to receive speed information) and configured to adjust the speed of the conveyor 6 to match the speed of the first machine and to adjust the speed of the conveyor 7 to match the speed of the second machine.

Referring in particular to FIGS. 11 and 12, according to some non-limiting embodiments, the joining device 9′ comprises a central element 42, over which, in use, the products 2 from the first conveyor 6 pass to the transfer conveyor assembly 8. The centring elements 9″ (rollers) are arranged on opposite sides of the central element 42 (and essentially integral with the central element 42).

Optionally, additionally or alternatively, the joining device 10′ comprises a central element 43, over which, in use, the products 2 from the transfer conveyor assembly 8 pass to the second conveyor 7. The centring elements 10″ (rollers) are arranged on opposite sides of the central element 43 (and substantially integral with the second central element 42).

In this way, it has been experimentally observed that the relative position of the transfer conveyor assembly 8 (in particular, of the connecting devices 9′ and 10′) with respect to the conveyors 6 and 7 is more stable and precise.

Advantageously, but not necessarily, the joining device 9′ comprises at least one adjustment device to adjust the position of the centring elements 9″ (rollers) with respect to the conveyor 6 (in particular, with respect to the guide 27). In particular, this allows the position of the centring elements 9″ (rollers) to be adjusted so that they are in contact with the guide 27.

Additionally or alternatively, the joining device 10′ comprises at least one adjustment device for adjusting the position of the centring elements 10″ (rollers) with respect to the conveyor 7 (in particular, with respect to the guide rail 29). In particular, this allows the position of the centring elements 10″ (roller) to be adjusted so that they are in contact with the guide 29.

In accordance with non-limiting embodiments, an adjustment device is provided for each centring element 9″ and 10″ (roller).

In some non-limiting cases, each adjustment device comprises (is) an eccentric (which can be operated, e.g. with a screwdriver or similar).

Advantageously, but not necessarily, the central element 42 has at least one distal portion 44 to the transfer conveyor assembly 8 (i.e. arranged at an end distal to the transfer conveyor assembly 8) tapered towards the conveyor 6.

Additionally or alternatively, the central element 43 has at least one distal portion 45 to the transfer conveyor assembly 8 (i.e. arranged at an end distal to the transfer conveyor assembly 8) tapered towards the second conveyor 7.

This facilitates the passage of products 2 from and to the transfer conveyor unit 8 while reducing the risk of clogging.

According to some non-limiting embodiments, the central elements 42 and serve as chutes.

Advantageously, but not necessarily, the transporting element 25 (in particular, a belt, strap and/or chain) is configured to slide along at least the segment S1 and has at least one depression 46 (in particular, at least two depressions 46) extending longitudinally along the transporting element 25 itself.

Additionally or alternatively, the transporting element 26 is configured to slide along at least the segment S2 and has at least one depression 47 (in particular, at least two depressions 47) extending longitudinally along the transporting element 26 itself.

In particular, the first central element 42 has at least one tine 48 (more particularly, at least two tines), which projects from the opposite side from the transfer conveyor assembly 8 (in particular, from the distal portion 44) and, in particular, extends at least partially inside the depression 46.

In addition or alternatively, the central element 43 has at least one tine 49 (more particularly, at least two tines), which projects from the opposite side from the transfer conveyor assembly 8 (in particular, from the distal portion 45) and, in particular, extends at least partially inside the depression 46.

In this way, it has been experimentally observed that the passage of products 2 from and to the transfer conveyor unit 8 is facilitated and the risk of clogging is reduced.

Advantageously, but not necessarily, each of the tines 48 and 49 is tapered towards its free end (in particular, away from the transfer conveyor assembly 8).

Advantageously, but not necessarily, the joining device 9′ comprises at least one lower roller 50 (in particular, a bearing) which is arranged in contact with the conveyor 6 (in particular, in contact with the transporting element 25; in particular, arranged between the central element 42 and the conveyor 6) and is configured to facilitate the sliding of the first joining device 9′ on the first conveyor 6. In particular, the lower roller 50 has an axis of rotation crosswise to the segment S1. It has been experimentally observed that, in this way, the sliding of the fittings 9′ and 10′ is better and the risk of clogging is reduced.

Additionally or alternatively, but not necessarily, the joining device 10′ comprises at least one lower roller 51 (in particular, a bearing) which is arranged in contact with the conveyor 7 (in particular, in contact with the transporting element 26; in particular, arranged between the central element 43 and the conveyor 7) and is configured to facilitate the sliding of the second joining device 10′ on the second conveyor 7. In particular, the lower roller 51 has an axis of rotation crosswise to the segment S2.

According to some non-limiting embodiments, the joining device 9′ comprises at least two lower rollers 50 not aligned with each other (and/or staggered, in particular with regard to the position along the segment S1). Additionally or alternatively, the joining device 10′ comprises at least two lower rollers 51 not aligned with each other (and/or staggered, in particular with regard to the position along the segment S2).

It has been experimentally observed that, in this way, the sliding of the fittings 9′ and 10′ is surprisingly smoother (with less jolting) and the risk of clogging is reduced. This behaviour was particularly observed when the transporting elements 25 and 26 had an irregular surface (e.g. chains).

It is supposed that this result is due to the fact that, with this structure, the lower rollers 50 (and/or 51) do not simultaneously lie in depressions (discontinuities) of the transporting element 25 (and/or 26).

Advantageously, but not necessarily, the joining device 9′ comprises at least one adjustment device for adjusting the position of the bottom roller(s) 50 with respect to the conveyor 6 (in particular, with respect to the transporting element 25).

Additionally or alternatively, the joining device 10′ comprises at least one adjustment device for adjusting the position of the bottom roller(s) 51 with respect to the conveyor 7 (in particular, with respect to the transporting element 26).

In particular, this makes it possible to adjust the position of the lower roller(s) 50 so that it is in correct contact with the transporting element 25 and/or the position of the lower roller(s) 51 so that it is in correct contact with the transporting element 26.

According to non-limiting embodiments, an adjusting device is provided for each of the lower rollers 50 and 51.

In some non-limiting cases, each adjustment device comprises (is) an eccentric (which can be operated, e.g. with a screwdriver or similar).

Advantageously but not necessarily, the conveying assembly 3 comprises a hinge 52, which is arranged between the joining device 9′ and the transfer conveyor assembly 8 and is configured to allow the joining device 9′ to pivot relative to the transfer conveyor assembly 8 about a respective pivoting axis (in particular, crosswise to the segment S1).

Additionally or alternatively, the conveying assembly 3 comprises a hinge 53, which is arranged between the joining device 10′ and the transfer conveyor assembly 8 and is configured to allow the joining device 10′ to pivot relative to the transfer conveyor assembly 8 about a respective pivoting axis (in particular, crosswise to the segment S1).

Again, surprisingly, a smoother movement of products 2 and a reduction in the risk of clogging were observed.

The store 1 according to the present invention has several advantages over the state of the art. Among others, it is possible to have an uncomplicated structure that allows relatively simple maintenance. Furthermore, the store 1 is particularly ductile, being able to have an output station at the top (a particularly convenient position for current machine layouts), and gentle handling of the products 2. The connections of the transfer conveyor assembly 8 with the conveyors 6 and 7 are stable and reliable. The risk of clogging of products 2 is also reduced.

Unless the contrary is explicitly specified, the content of the references (products, books, patent applications, etc.) cited in this text is referred to in full herein. In particular, the mentioned references are incorporated herein by reference.

### LIST OF REFERENCE NUMBERS OF THE FIGURES

1 store
2 products
3 conveying assembly
4 input station
5 output station
6 conveyor
7 conveyor
8 transfer conveyor assembly
9 input
10 output
11 feeding device
12 moving assembly
13 pulley
14 pulley
15 pulley
16 feeding device
17 plate
18 slits
19 flat supports
20 slits
21 deflection belt
22 deflection belt
23 motorised pulley
24 motorised pulley
25 transporting element
26 transporting element
27 guide
28 recess
29 guide
30 support structure
31 base
32 column
33 support assembly
34 support assembly
35 bearing
36 fixed portion
37 movable portion
38 arms
42 central element
43 central element
44 distal portion
45 distal portion
46 depression
47 depression
48 tine
49 tine
50 lower roller
51 lower roller
52 hinge
53 hinge
9′ joining device
10′ joining device
16′ pulleys
9″ centring elements
10″ centring elements
A axis
P path
S1 segment
S2 segment
IS intermediate segment
SC2 connecting segment
SC2 connecting segment
AT active segment
PT passive segment

1. A variable-capacity store for products (2), the store (1) comprises a conveying assembly (3) for conveying the products (2) from an input station (4) to an output station (5) along a path (P) with a variable length;
the conveying assembly (3) comprises:
a first conveyor (6), which is configured to convey the products (2) from the input station (4) along a first segment (SI) of the path (P);
at least one second conveyor (7), which is configured to convey the products (2) to the output station (5) along a second segment (S2) of the path (P); and
at least one transfer conveyor assembly (8), which is configured to convey the products (2) from the first conveyor (6) to the second conveyor (7) along an intermediate segment (IS) of the path (P) and has an input (9), which is arranged in the area of the first segment (SI) so as to receive the products (2) from the first conveyor (6), and an output (10), which is arranged in the area of the second segment (S2) so as to convey the products (2) to the second conveyor (7); the first segment (SI) extends from the input station (4) to the input (9); the second segment (S2) extends from the output (10) to the output station (5);
a moving assembly (12) to move the transfer conveyor assembly (8) so as to move said input (9) and said output (10) along the first and the second conveyor (6, 7), respectively;
a first joining device (9), which is configured to permit the transit of the products (2) from the first conveyor (6) to the transfer conveyor assembly (8) and is movable on the first conveyor (6); and
a second joining device (10′), which is configured to permit the transit of the products (2) from the transfer conveyor assembly (8) to the second conveyor (7) and is movable on the second conveyor (7);
wherein the first joining device (9′) comprises at least two first centering elements (9″), which are arranged on opposite sides of the first conveyor (6) in order to reduce the lateral movement of the first joining device (9′) relative to the first conveyor (6) and each of which comprises at least one first roller and/or the second joining device (10′) comprises at least two second centering elements (10″), which are arranged on opposite sides of the second conveyor (7) in order to reduce the lateral movement of the second joining device (10′) relative to the second conveyor (7) and each of which comprises at least one second roller.

2. The store according to claim 1, wherein the first conveyor (6) comprises a first guide (27) and a first transporting element (25), which is configured to slide on the first guide (27);
the first centering elements (9″) are arranged on opposite sides of the first guide (27) and substantially in contact with the first guide (27);
the second conveyor (7) comprises a second guide (29) and a second transporting element (26), which is configured to slide on the second guide (29);
the second centering elements (10″) are arranged on opposite sides of the second guide (29) and substantially in contact with the second guide (29).

3. The store according to claim 1, wherein the conveying assembly (3) comprises the first joining device (9′) and the second joining device (10′); and/or, the conveying assembly (3) comprises the at least two first centering elements (9″) and the least two second centering elements (10″).

4. The store according to claim 1, wherein the first joining device (9′) comprises a first central element (42) having at least one distal portion (44) relative to the transfer conveyor assembly (8), which is tapered towards the first conveyor (6).

5. The store according to claim 1, wherein the first joining device (9′) comprises a first central element (42), on which, in use, the products (2) move from the conveyor (6) to the transfer conveyor assembly (8);
the first centering elements (9″) are arranged on opposite sides of the first central element (42);
the second joining device (10′) comprises a second central element (43), on which, in use, the products (2) move from the transfer conveyor assembly (8) to the second conveyor (7);
the second centering elements (10″) are arranged on opposite sides of the second central element (43).

6. The store according to claim 5, wherein the first conveyor (6) comprises a first transporting element (25), which is configured to slide along at least said first segment (SI) and has at least one first depression (46), which longitudinally extends along the first transporting element (25) itself; the second conveyor (7) comprises a second transporting element (26), which is configured to slide along at least said second segment (S2) and has at least one second depression (47), which longitudinally extends along the second transporting element (26) itself;
the first central element (42) has at least one first tine (48), which projects on the opposite side relative to the transfer conveyor assembly (8) and at least partially extends inside the first depression (46);
the second central element (43) has at least one second tine (49), which projects on the opposite side relative to the transfer conveyor assembly (8) and at least partially extends inside the second depression (46).

7. The store according to claim 1, wherein the first joining device (9′) comprises at least one first lower roller (50), which is arranged in contact with the first conveyor (6) and is configured to help the first joining device (9′) move on the first conveyor (6);
the second joining device (10′) comprises at least one second lower roller (51), which is arranged in contact with the second conveyor (7) and is configured to help the second joining device (10′) move on the second conveyor (7).

8. The store according to claim 7, wherein the first joining device (9′) comprises a first central element (42), on which, in use, the products (2) move from the first conveyor (6) to the conveying assembly (3);
the second joining device (10′) comprises a second central element (43), on which, in use, the products (2) move from the conveying assembly (3) to the second conveyor (7);
said at least one first lower roller (50) has a first axis of rotation crosswise to the first segment (SI) and is arranged between the first central element (42) and the first conveyor (6);
said at least one second lower roller (51) has a second axis of rotation crosswise to the second segment (S2) and is arranged between the second central element (43) and the second conveyor (7).

9. The store according to claim 7, wherein the first joining device (9′) comprises at least two first lower rollers (50), which are not aligned with one another;
the second joining device (10′) comprises at least two second lower rollers (51), which are not aligned with one another.

10. The store according to claim 1, wherein the conveying assembly (3) comprises a first hinge (52), which is arranged between the first joining device (9′) and the transfer conveyor assembly (8) and is configured to allow the first joining device (9′) to pivot relative to the transfer conveyor assembly (8) about a first pivoting axis;
the conveying assembly (3) comprises a second hinge (53), which is arranged between the second joining device (10′) and the transfer conveyor assembly (8) and is configured to allow the second joining device (10′) to pivot relative to the transfer conveyor assembly (8) about a second pivoting axis.

11. The store according to claim 10, wherein the first pivoting axis is crosswise to said first segment (SI); the second pivoting axis is crosswise to said second segment (S2).

12. The store according to claim 1, wherein the moving assembly (12) is configured to move the transfer conveyor assembly (8) so as to move said input (9) and said output (10) along the first and the second conveyor (6, 7), respectively, and change the length of the intermediate segment (IS) and of the first and the second segment (SI, S2);
the first conveyor (6) has at least one turn; the second conveyor (7) has at least one turn;
the conveying assembly (3) comprises the first joining device (9′) and the second joining device (10′);); and/or the conveying assembly (3) comprises the at least two first centering elements (9″) and the least two second centering elements (10″).

13. The store according to claim 12, wherein the first and the second conveyor (6, 7) are arranged in such a way that one is at least partially above the other one; the turning direction of the first conveyor (6) being contrary to the turning direction of the second conveyor (7).

14. The store according to claim 12, wherein the first and the second conveyor (6, 7) have turns that are substantially coaxial to one another.

15. The store according to claim 1, wherein the transfer conveyor assembly (8) has at least one feeding device (16) configured to at least partially accompany the products (2), by moving along the intermediate segment (IS).

16. The store according to claim 1, wherein each first joining device (9′) is the first roller; and/or each second joining device (10′) is the second roller.

17. The store according to claim 1, wherein the first conveyor (6) comprises a first guide (27) and a first conveyor element (25), which is configured to run on the first guide (27); the first rollers are arranged on opposite sides of the first guide (27) and substantially in contact with the first guide (27); and/or
the second conveyor (7) comprises a second guide (29) and a second conveyor element (26), which is configured to run on the second guide rail (29); the second rollers are arranged on opposite sides of the second guide (29) and are substantially in contact with the second guide (29).

18. The store according to claim 14, wherein the first conveyor (6) has a plurality of first turns (coils); the second conveyor (7) has a plurality of second turns having the same radius and the same distance as the first turns.
